(19) United States
(12) Patent Application Publication
(10) Pub. No.: US 2026/0208219 A1
(43) Pub. Date: Jul. 23, 2026

(54) MIST-SPRAY WATER TANK AND MIST-SPRAY TOY TRAIN

(71) Applicant: Weihuai LIN, Shantou (CN)

(72) Inventor: Weihuai LIN, Shantou (CN)

(21) Appl. No.: 19/430,343

(22) Filed: Dec. 23, 2025

(30) Foreign Application Priority Data
Jan. 21, 2025 (CN) 202520140879.3

(51) Int. Cl. B05B 15/60; A63H 21/00

(52) U.S. Cl. CPC B05B 15/60; A63H 21/00

(57) ABSTRACT

The mist-spray water tank includes a water tank body, a water tank lid, a water-absorbing rod, and a top atomizing plate. One end of the water tank lid is provided with an annular groove for installing the top atomizing plate, and a through hole is opened in a center of the annular groove. An upper end of the annular groove is provided with a top atomizing plate pressing member. The other end of the water tank lid is provided with a water injection hole. The water-absorbing rod is vertically positioned inside the water tank body, and a top end of the water-absorbing rod passes through the through hole and abuts against bottom of the top atomizing plate. A side mist-spray nozzle is provided on a side of the bottom of the water tank body, and a side atomizing plate is sealed on an outer side of the side mist-spray nozzle.

### CROSS REFERENCE TO THE RELATED APPLICATIONS

This application is based upon and claims priority to Chinese Patent Application No. 202520140879.3, filed on Jan. 21, 2025, the entire contents of which are incorporated herein by reference.

### TECHNICAL FIELD

The present disclosure relates to the technical field of toy model, and in particular to a mist-spray water tank and a mist-spray toy train.

### BACKGROUND

With the increasing maturity of mold technology, the simulation level of various toy models is becoming higher and higher, making today's toy models both toys and collectibles. Train models are a popular product among model toys and are loved by users. For example, prior art CN219050309U discloses a mist-spray locomotive model and train set model, where the locomotive model is equipped with a mist-spray water tank, which has the effect of spraying mist from three spray nozzles on the top and sides of the locomotive, achieving the effect of realistic steam train exhaust. However, the following problems were found in the actual production and use of the mist-spray tank: (1) The entire tank body is assembled by left and right composite components through glue or ultrasonic welding, which is prone to leakage due to unstable adhesion and tank breakage after product drops, resulting in a short service life; (2) When the left and right composite components are directly adhered, the glue is uncontrollable and easily adheres to the working area of the atomizing plate, causing the atomizing plate to malfunction. The glue may also block the water inlet, affecting the performance; (3) When the water tank is full, the water pressure at the bottom of the left and right sides exceeds the working power of the atomizing plate, causing the atomizing plate to malfunction. Furthermore, when the water level in the water tank is lower than the atomizing plate, the atomizing plate cannot work properly, resulting in a large amount of water remaining in the water tank but no normal spraying, affecting the user experience.

Therefore, the existing mist-spray water tanks mentioned above clearly still have inconveniences and defects in terms of structure, method, and use, and urgently need further improvement. How to create and design a novel mist-spray water tank and mist-spray toy train with a simple structure, convenient production, resistance to breakage, good atomization effect, and long service life has become a pressing goal for the industry.

### SUMMARY

The technical problem the present disclosure aims to solve is to provide a mist-spray water tank with a simple structure, convenient production, resistance to breakage, good atomization effect, and long service life, thereby overcoming the shortcomings of existing mist-spray water tanks.

To solve the above-mentioned technical problems, the present disclosure provides a mist-spray water tank, including a water tank body, a water tank lid, a water-absorbing rod, and a top atomizing plate; where the water tank lid is located at an upper opening of the water tank body; one end of the water tank lid is provided with an annular groove for installing the top atomizing plate, and a through hole is opened in a center of the annular groove; an upper end of the annular groove is also provided with a top atomizing plate pressing member with an air outlet; and the other end of the water tank lid is provided with a water injection hole, and a water inlet cap is provided on the water injection hole;
the water-absorbing rod is vertically positioned inside the water tank body, and a top end of the water-absorbing rod passes through the through hole of the annular groove and abuts against a bottom of the top atomizing plate, drawing water from a bottom of the water tank body upwards into the top atomizing plate; and
the top atomizing plate is configured to atomize the water conveyed by the water-absorbing rod into a water mist, and the water mist is discharged from the air outlet of the top atomizing plate pressing member.

In a further improvement, the water tank body adopts an inverted right-angled trapezoidal shape, smaller at the bottom and larger at a top, and a bottom of the water-absorbing rod is located at a deepest point of the water tank body.

In a further improvement, the bottom of the water tank body is provided with limiting protrusions for fixing a bottom end of the water-absorbing rod, and the limiting protrusions are discontinuous annular protrusions.

In a further improvement, a side mist-spray nozzle is provided on a side of the bottom of the water tank body, and a side atomizing plate is provided on an outer side of the side mist-spray nozzle; and a sealing groove is provided around an outer periphery of the side mist-spray nozzle, and the side atomizing plate is sealed and fixed by sealant in the sealing groove.

In a further improvement, a baffle is provided on an inner bottom surface of the water tank body, and the baffle is located on an inner side of the side mist-spray nozzle, for reducing pressure of a water level inside the water tank body on the side atomizing plate.

In a further improvement, the side mist-spray nozzle is provided on each of left and right sides of the bottom of the water tank body.

In a further improvement, the water tank body is of a one-piece injection-molded structure.

In a further improvement, the water tank lid and the water tank body are sealed by ultrasonic welding.

As another improvement of the present disclosure, a mist-spray toy train is also provided, and a locomotive section of the toy train is provided with the mist-spray water tank mentioned above.

With this design, the present disclosure offers at least the following advantages:

By improving the overall structure of the mist-spray water tank to form a one-piece water tank body, and by setting the sealing groove on the outer side of the side mist-spray nozzle, the leakage problem of the water tank can be effectively overcome, achieving good waterproof and drop-proof performance and extended service life of the water tank.

Furthermore, by setting the baffle inside the water tank, the water pressure on the side atomizing plate is reduced using the baffle when the water tank body is full in water. The siphon principle formed by the gap between the baffle and the side wall of the water tank ensures that water can still be drawn to the side atomizing plate even when the water level inside the water tank body is low. This allows the side atomizing plate to perform atomization normally whether the water tank is full or low in water, extending the atomization time and improving the user experience.

### BRIEF DESCRIPTION OF THE DRAWINGS

The above is merely an overview of the technical solution of the present disclosure. To better understand the technical means of the present disclosure, the following detailed description is provided in conjunction with the drawings and specific embodiments.

FIG. 1 is a schematic diagram showing the structure of the mist-spray water tank according to the present disclosure.

FIG. 2 is an exploded diagram showing the structure of the mist-spray water tank according to the present disclosure.

FIG. 3 is a schematic diagram showing the structure of the bottom of the water tank body in the mist-spray water tank according to the present disclosure.

FIG. 4 is a schematic diagram showing the structure of the inner bottom surface of the water tank body in the mist-spray water tank according to the present disclosure.

### DETAILED DESCRIPTION OF THE EMBODIMENTS

Exemplary embodiments of the present disclosure will be described in more detail with reference to the drawings. Although exemplary embodiments of the present disclosure are shown in the drawings, it should be understood that the present disclosure can be implemented in various forms and should not be limited to the embodiments set forth herein. Rather, these embodiments are provided to enable a more thorough understanding of the present disclosure and to fully convey the scope of the present disclosure to those skilled in the art.

It should be noted that, unless otherwise expressly specified and limited, the terms “installation,” “connection,” and “linking” should be interpreted broadly. For example, they can refer to a fixed connection, a detachable connection, or an integral connection; they can refer to a mechanical connection or an electrical connection; they can refer to a direct connection or an indirect connection through an intermediate medium; and they can refer to the internal connection of two components. One of ordinary skill in the art can understand the specific meaning of the above terms in the present disclosure based on the specific circumstances.

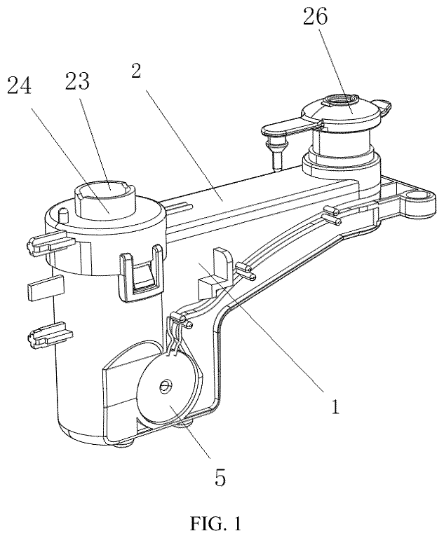

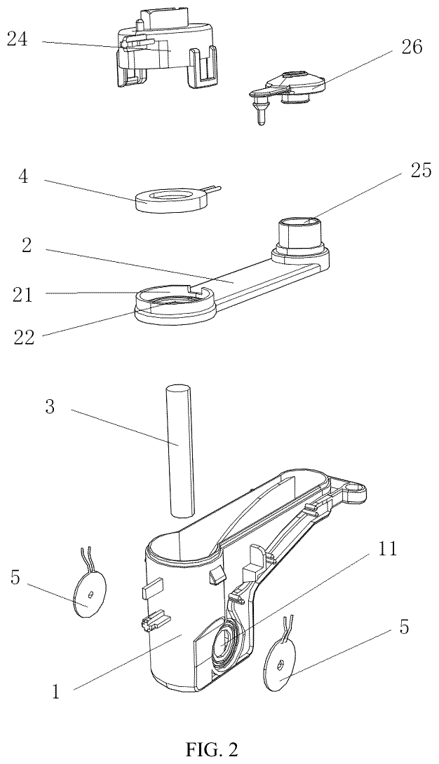

Referring to FIGS. 1-2, the mist-spray water tank of this embodiment includes the water tank body 1, the water tank lid 2, the water-absorbing rod 3, and the top atomizing plate 4.

In this embodiment, the water tank body 1 adopts an inverted right-angled trapezoidal shape, smaller at the bottom and larger at the top, reducing the bottom area of the tank to maximize the atomization of the water inside and improve the user experience. The water tank body 1 in this embodiment adopts a one-piece injection-molded structure, effectively overcoming the defects caused by adhering left and right composite components, resulting in good waterproof and drop-proof performance and a long service life.

In this embodiment, the water tank lid 2 is located at the upper opening of the water tank body 1 and is sealed by ultrasonic welding. One end of the water tank lid 2 is provided with the annular groove 21 for installing the top atomizing plate 4, and the through hole 22 is opened in the center of the annular groove 21. The upper end of the annular groove 21 is also provided with the top atomizing plate pressing member 24 with the air outlet 23. The other end of the water tank lid 2 is provided with the water injection hole 25 for filling the water tank body 1 with water. The water inlet cap 26 is provided on the water injection hole 25.

The water-absorbing rod 3 is vertically positioned inside the water tank body 1, at the deepest point of the water tank body 1, to maximize the use of water within the water tank. The t op end of the water-absorbing rod 3 passes through the through hole 22 of the annular groove 21 and abuts against the bottom of the top atomizing plate 4, drawing water from the bottom of the water tank body 1 upwards into the top atomizing plate 4. The top atomizing plate 4 then atomizes the water into the water mist, and the water mist is discharged from the air outlet 23 of the top atomizing plate pressing member 24, creating a top mist-spray effect.

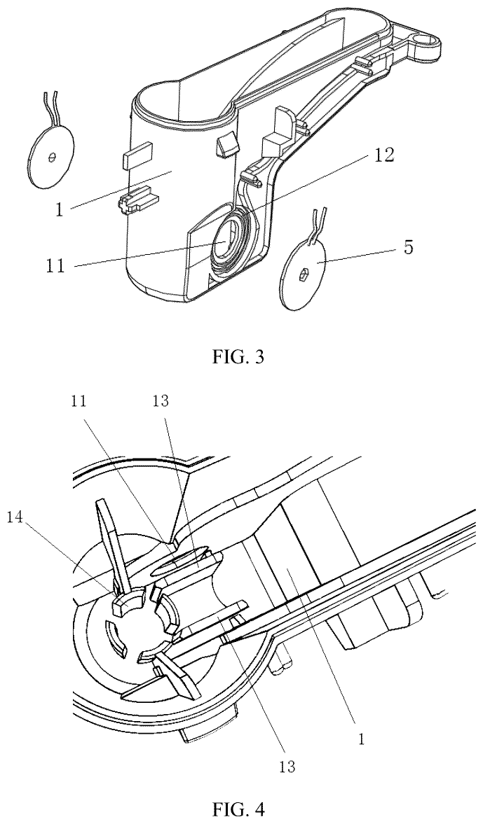

In the preferred embodiment, the side mist-spray nozzle 11 is provided on each of the left and right sides of the bottom of the water tank body 1. The side atomizing plate 5 is provided on the outer side of the side mist-spray nozzle 11. The sealing groove 12 is provided around the outer periphery of the side mist-spray nozzle 11, as shown in FIG. 3. This allows the side atomizing plate 5 to be sealed and fixed by the sealant in the sealing groove 12, preventing leakage.

In the more preferred embodiment, referring to FIG. 4, the baffles 13 are provided on the inner bottom surface of the water tank body 1. The baffle 13 is located on the inner side of the side mist-spray nozzle 11, forming the gap with the side wall of the water tank body 1. This reduces the pressure of the water level inside the water tank body 1 on the side atomizing plate 5, ensuring that the side atomizing plate 5 can maintain normal operation even when the water tank is full. Furthermore, the gap between the baffle 13 and the side wall of the water tank body 1 also facilitates the siphon effect, allowing the water to be drawn onto the side atomizing plate 5 even when the water level in the water tank is lower than the center position of the side atomizing plate 5, extending the atomization time and improving the user experience.

Furthermore, as shown in FIG. 4, the bottom of the water tank body 1 is also provided with the limiting protrusions 14 for fixing the bottom end of the water-absorbing rod 3. The limiting protrusions 14 are the discontinuous annular protrusions, ensuring that the bottom end of the water-absorbing rod 3 always has water.

In this embodiment, both the top atomizing plate 4 and the side atomizing plate 5 adopt existing general-purpose atomizing plates, ensuring the uniform atomization effect.

By placing the aforementioned mist-spray water tank on the locomotive section of a toy train mold, a realistic smoke and vapor effect can be achieved from the top and sides of the toy train, resulting in excellent simulation and a superior user experience.

The water tank body in the present disclosure adopts the one-piece injection-molded structure, with the sealing groove on the outer side of the side mist-spray nozzle, thereby achieving better waterproof and drop-proof performance, leak prevention, and an extended service life of the water tank. Furthermore, the inclusion of the baffle inside the water tank cleverly ensures that the side atomizing plates function properly whether the water tank is full or low in water, enhancing the user experience and strengthening market competitiveness.

The above description is merely the preferred embodiment of the present disclosure and does not constitute any limitation on the present disclosure. Any simple alterations, equivalent changes, or modifications made by those skilled in the art using the disclosed technical content fall within the protection scope of the present disclosure.

What is claimed is:

1. A mist-spray water tank, comprising a water tank body, a water tank lid, a water-absorbing rod, and a top atomizing plate; wherein the water tank lid is located at an upper opening of the water tank body; a first end of the water tank lid is provided with an annular groove for installing the top atomizing plate, and a through hole is opened in a center of the annular groove; an upper end of the annular groove is provided with a top atomizing plate pressing member with an air outlet; and a second end of the water tank lid is provided with a water injection hole, and a water inlet cap is provided on the water injection hole;
the water-absorbing rod is vertically positioned inside the water tank body, and a top end of the water-absorbing rod passes through the through hole of the annular groove and abuts against a bottom of the top atomizing plate, drawing water from a bottom of the water tank body upwards into the top atomizing plate; and
the top atomizing plate is configured to atomize the water conveyed by the water-absorbing rod into a water mist, and the water mist is discharged from the air outlet of the top atomizing plate pressing member.

2. The mist-spray water tank according to claim 1, wherein the water tank body adopts an inverted right-angled trapezoidal shape, smaller at the bottom of the water tank body and larger at a top of the water tank body, and a bottom of the water-absorbing rod is located at a deepest point of the water tank body.

3. The mist-spray water tank according to claim 2, wherein the bottom of the water tank body is provided with limiting protrusions for fixing a bottom end of the water-absorbing rod, and the limiting protrusions are discontinuous annular protrusions.

4. The mist-spray water tank according to claim 2, wherein a side mist-spray nozzle is provided on a side of the bottom of the water tank body, and a side atomizing plate is provided on an outer side of the side mist-spray nozzle; and a sealing groove is provided around an outer periphery of the side mist-spray nozzle, and the side atomizing plate is sealed and fixed by sealant in the sealing groove.

5. The mist-spray water tank according to claim 4, wherein a baffle is provided on an inner bottom surface of the water tank body, and the baffle is located on an inner side of the side mist-spray nozzle, for reducing pressure of a water level inside the water tank body on the side atomizing plate.

6. The mist-spray water tank according to claim 5, wherein the side mist-spray nozzle is provided on each of left and right sides of the bottom of the water tank body.

7. The mist-spray water tank according to claim 1, wherein the water tank body is of a one-piece injection-molded structure.

8. The mist-spray water tank according to claim 7, wherein the water tank lid and the water tank body are sealed by ultrasonic welding.

9. A mist-spray toy train, wherein a locomotive section of the mist-spray toy train is provided with the mist-spray water tank according to claim 1.

10. The mist-spray toy train according to claim 9, wherein in the mist-spray water tank, the water tank body adopts an inverted right-angled trapezoidal shape, smaller at the bottom of the water tank body and larger at a top of the water tank body, and a bottom of the water-absorbing rod is located at a deepest point of the water tank body.

11. The mist-spray toy train according to claim 10, wherein in the mist-spray water tank, the bottom of the water tank body is provided with limiting protrusions for fixing a bottom end of the water-absorbing rod, and the limiting protrusions are discontinuous annular protrusions.

12. The mist-spray toy train according to claim 10, wherein in the mist-spray water tank, a side mist-spray nozzle is provided on a side of the bottom of the water tank body, and a side atomizing plate is provided on an outer side of the side mist-spray nozzle; and a sealing groove is provided around an outer periphery of the side mist-spray nozzle, and the side atomizing plate is sealed and fixed by sealant in the sealing groove.

13. The mist-spray toy train according to claim 12, wherein in the mist-spray water tank, a baffle is provided on an inner bottom surface of the water tank body, and the baffle is located on an inner side of the side mist-spray nozzle, for reducing pressure of a water level inside the water tank body on the side atomizing plate.

14. The mist-spray toy train according to claim 13, wherein in the mist-spray water tank, the side mist-spray nozzle is provided on each of left and right sides of the bottom of the water tank body.

15. The mist-spray toy train according to claim 9, wherein in the mist-spray water tank, the water tank body is of a one-piece injection-molded structure.

16. The mist-spray toy train according to claim 15, wherein in the mist-spray water tank, the water tank lid and the water tank body are sealed by ultrasonic welding.
